(19) United States
(12) Patent Application Publication
(10) Pub. No.: US 2003/0136274 A1
(43) Pub. Date: Jul. 24, 2003

(54) Methods and apparatus for the application of honey to wounds

(76) Inventor: Phillip Roy Caskey, Cambridge (NZ)

Correspondence Address: MASON, MASON & ALBRIGHT, 2306 South Eads Street, P.O. Box 2246, Arlington, VA, 22202, US

(21) Appl. No.: 10/330,101

(22) Filed: Dec. 30, 2002

Related U.S. Application Data
(63) Continuation of application No. PCT/NZ01/00130, filed on Dec. 30, 2002.

(30) Foreign Application Priority Data
Jun. 30, 2000 (NZ) 505497

(51) Int. Cl. A23B 4/02

(52) U.S. Cl. 99/494

(57) ABSTRACT

An applicator for applying a honey composition topically a site, the applicator including, a sealable reservoir, and a pressure assembly, and a nozzle assembly in fluid communication with each other once the seal is breached, characterised in that the scalable reservoir holds a preferred quantity of the honey composition in a fluid form and the pressure assembly is fitted to the reservoir in order to apply pressure to the honey composition contained within the reservoir, for effecting transfer of the honey composition from the reservoir and the nozzle assembly attached to the reservoir assembly directs the honey composition to the site.

### TECHNICAL FIELD

This invention is directed to improvements in and relating to methods and apparatus for the application of honey to wounds.

In particular, it is envisaged the invention will have particular use in the application of a preferred honey composition having appropriate viscosity and therapeutic properties to infected and non-infected, exudating wounds. The application appropriately localising the preferred honey composition in relation to the wound and in a required dose.

The honey is applied via a sterile applicator that may contain sufficient honey composition for a single dose or for subsequent applications of the honey composition to the wound.

However, this invention could have application outside this field.

### BACKGROUND ART

There is available in the background art a range of medicaments that may be applied to wounds in order to assist in the healing of those wounds. Said medicaments are available in a range of forms from very fluid to substantially viscous and gel-like.

The fluid medicaments may be used as a wash over a general area to which the medicament is to be applied. Iodine-based washes are an example. Alternately, more viscous products may be applied as creams, salves, gels and so forth that are applied directly on to the wound or in the vicinity of an area being treated.

The various medicaments may of course comprise a range of products such as pharmaceuticals including fungicides, antibiotics, or hormone-based compounds such as steroids—whether naturally occurring or synthetically produced. Alternatively, they may simply include chemical compounds known to have preferred effects, such as iodine washes and calcium compounds. The medicaments may be produced from or include various plant extracts or vitamins (again whether natural or synthetic) having properties that aid the healing process, minimise inflammation, reduce or prevent infection by microbes, provide pain relief, assist in blood clotting or protect the skin, and so forth.

Some products may be specifically incorporated into dressings to localise the therapeutic treatment in the required area.

The topical application of ointments and so forth is therefore well documented and many of the products are available over the counter from supermarkets or pharmacies or via prescription from health professionals.

The use of therapeutic bee products has also been known historically to be successful for a variety of common medical conditions and ailments. In New Zealand, some honey products, particularly honey produced from plants belonging to the genus Leptospermum, such as Manuka, have demonstrated a unique factor (non-peroxide activity) that has therapeutic benefits. In relation to Manuka honey the factor has been labeled “unique Manuka factor” (UMF)®. Other honeys including honey produced from Rewa Rewa and so forth have varying amounts of the non peroxide activity.

The therapeutic benefits of honey products such as these, have particular application in the field of chronic wound care, and particularly for infected wounds. Such honeys have been found to exhibit non-peroxide (antibacterial activity/phenol activity) as well as peroxide activity. Both of these activities are particularly advantageous in the care of wounds. The properties of honey have been identified as beneficial in chronic wound care because:

a) it contributes to osmotic absorption of excess exudate; and

b) the peroxide activity of honey is both wound cleansing and helps with wound bed oxygenation; and

c) honey products also aid healing by providing beneficial nutrients to the wound bed, improving skin cell regeneration; and

d) minimal side effects result with the use of honey as compared with pharmaceuticals (although some patients who are allergic to bees and bee products are less appropriate subjects for such treatment); and

e) honey that demonstrates “active”, non-peroxide properties is suited to the treatment of microbial infections.

Increased awareness over the recent years of moist wound healing in the chronic wound care sector, has presented an ideal environment in which the use of honey in the treatment of wounds has progressed.

Chronic wounds are assessed on three major indices:

a) their exudate level,

b) tissue types present, and

c) their depth.

The presence of infection, underlying disease, aetiology, the patients' general condition and co-existing disease or medications are other important factors.

The use of honey products provides an alternative to traditional medicine in that honey is safe to apply (unless a patient is allergic to honey products) and thereby provides an alternative that obviates many of the concerns and considerations incumbent with existing medicaments applied to wounds. Honey based wound care products are suitable for two main categories of wounds in the area of chronic wound care.

These two main categories:

a) exudating wounds that are not infected; and

b) exudating wounds that are infected.

In the second category, wound healing is not the primary aim. Once the infection is under control, then attention can be directed to wound healing.

As can be appreciated, when infected wounds are being treated it is important to contain the infection. Accordingly, there are issues associated with the application of medicaments or treatments to the wounds to ensure:

a) that the medicament is applied to the part of the wound required to be treated; and

b) there is no cross-infection from one site to another; and

c) that the medicament can be easily applied; and

d) that the patient experiences minimal discomfort in the application of the medicament to the wound.

Existing methods of applying medicaments to wounds include spray application. This method has proved successful only in relation to particularly fluid products. Pressurised systems, including pump sprays may be used in the delivery of such products.

Alternatively, creams, ointments, salves, gels may be applied directly to the wound by depositing a portion of the product on to the wound, or on to material, that is then wiped across the wound to spread the deposited portion over the required area. This method requires the use of an applicator such as a swab or similar. Alternately, a portion may be applied to a dressing that is in turn applied to the wound.

Body temperature is used to soften the product that will then spread around the wound, but the portion of product is maintained on or in the vicinity of the wound as a result of the dressing holding it in place.

As can be appreciated, there are problems associated with the above methods. For example, with spray application of a medicament on to a wound area, the fluid nature of the product in the jet stream may mean that the product is distributed over an area greater than required, as opposed to being localised specifically on the wound. Also typically, such application methods are suited to more liquid products. Dispensing more viscous products by this method may be limited.

Where a salve, ointment, gel and so forth is applied directly onto a wound and then spread around the wound the patient may experience some discomfort associated with the pressure being applied to the wound during the spreading action. Also, such products are typically administered from a tube or container in which the products are available. The amount of product applied to the wound is therefore under minimal control and depends upon the amount of pressure applied to the tube or container to squeeze an appropriate amount of the medicament onto the wound. Accordingly, over or under application may occur.

Where the product or medicament is applied to a dressing and then deposited onto the wound, some of the medicament may be absorbed into the dressing and thereby is unavailable for direct contact between the wound and the product. In addition, in the absence of spreading out the product, it requires the dressing be appropriately located on the wound to ensure the medicament is primarily in the vicinity of the wound.

Further, properties of many medicaments may cause discomfort—by irritating the wound, causing the area to smart and so forth. This sensation, discomfort and/or pain may be exacerbated where pressure is applied to the area in spreading out the medicament.

It would therefore be advantageous to have available a suitable method and apparatus for applying a medicament to a wound. Given the recognised advantages of the use of honey in chronic wound care, and particularly in relation to exudating wounds, it would be particularly advantageous if the method and apparatus could:

a) be used to apply a preferred honey composition having preferred properties, including a preferred viscosity directly to a wound area; and

b) be used to apply a preferred quantity of the honey composition to the wound area; and

c) minimise the need to spread the honey composition over the wound thereby minimising discomfort to the patient; and

d) be easy to use; and

e) be sterile; and

f) be used as discrete, single applications, or for multiple applications; and

g) be used for both infected and non-infected wounds.

It is an object of the present invention to address at least some of the foregoing problems or at least to provide the public with a useful choice.

Further aspects and advantages of the present invention will become apparent from the ensuing description which is given by way of example only.

### DISCLOSURE OF INVENTION

According to one aspect of the present invention there is provided an applicator for applying a honey composition topically to a site, including

a sealable reservoir, and

a pressure assembly, and

a nozzle assembly,

characterised in that

the sealable reservoir holds a preferred quantity of the honey composition in a fluid form and the pressure assembly is fitted to the reservoir for effecting transfer of the honey composition from the reservoir and the nozzle assembly is attached to the reservoir assembly and directs the honey composition to the site.

In preferred embodiments of the present invention the site to which the honey composition is applied is either a wound or an item that is to be brought into contact with a wound—such as a wound dressing.

In preferred embodiments of the present invention the configuration of a nozzle assembly is determined by the required spread and quantity of the honey composition to be applied to the site.

Throughout the present specification the term “pressure assembly” should be understood to mean any means by which the contents of a reservoir can be ejected from the reservoir under pressure, examples of this include a plunger system wherein a plunger is depressed through a barrel (such as in a syringe), pneumatic or hydraulic assemblies which can be actuated directly by an operator's hand or may be actuated indirectly via a lever or other mechanical system.

It should also be understood to include systems such as spray cans wherein the contents of the reservoir are under pressure from an accelerant such as compressed air, wherein a releasing valve assembly can be depressed to enable the pressurised honey composition to be expelled from the reservoir.

It should be appreciated however that this should be in no way seen to be a limitation on the present invention as in other embodiments the pressure assembly can be any device capable of providing adequate pressure to expel the contents of the reservoir out of the applicator.

In some preferred embodiments of the present invention a substantially fluid honey composition is placed into the reservoir.

However, in some other preferred embodiments of the present invention the contents of the reservoir are pressurised so that the contents of the reservoir form a substantially gel-like consistency on leaving the reservoir.

It should be understood that within the present invention the honey composition used will have at least one of the following:

a preferred viscosity,

a preferred pH,

at least one preferred optional agent.

It is understood that the optional agents for use with the present invention include any of the following:

gelling agents,

pharmaceuticals (for example anti-microbial, hormonal, vitamin compounds),

chemical compounds (for example calcium),

plant extracts (for example flavanoids).

These optional agents are added to the honey composition in order to improve its efficacy in the wound care application.

According to another aspect of the present invention there is provided a method of applying a honey composition to a site using an applicator substantially as described above

characterised by the steps of

a) determining the quantity of honey composition to be applied to the site; and

b) removing the seal of the reservoir and replacing the seal with the nozzle assembly to effect the preferred application of the honey composition to the site; and

c) operating the pressure assembly for the required time period to transfer a desired quantity of the honey composition from the applicator reservoir to the vicinity of the site.

In preferred embodiments of the present invention the applicator is sterilised by irradiation.

Also within preferred embodiments of the present invention the honey composition is irradiated. This can be done prior to its insertion in the reservoir or whilst it is in the reservoir.

Throughout this specification the term “applicator” should be understood to mean any apparatus that may be used in the application of the honey composition to a range of wounds of various sizes.

Throughout this specification the term “reservoir” should be understood to mean any apparatus that may be used to contain a volume of the honey composition.

Throughout this specification the term “nozzle assembly” should be understood to mean any device through which a substance is able to be dispensed, including nozzles having varyingly configured apertures, openings, spouts, outlets and so forth through which the substance passes to effect a pattern of delivered substance dictated by the configuration of the aperture.

In preferred embodiments of the present invention the applicator includes both a syringe-type applicator and a pressurised spray-type applicator. However, any other suitable format of the applicator may be employed.

The following description however will relate to these two embodiments, although other embodiments should not be viewed as being specifically excluded from this invention.

In embodiments where the applicator is in the form of a syringe, the syringe dimensions may be varied according to the preferred quantity of the honey composition to be applied to the site.

As can be appreciated, where wounds are concerned, external sources of infection to the wound should be minimised.

Therefore a disposable applicator, such as that in the form of a syringe body particularly adapted to cope with viscous fluids such as the honey-composition being used within the scope of this invention, is particularly advantageous.

However, in some applications, such as in areas requiring skin grafts for instance, the extent of the wound covers a substantial area and the use of syringe-type applicators may impact on the ability to apply the honey composition efficiently and effectively. Accordingly, applicators having a greater capacity reservoir would be preferable in these situations.

Wounds are particularly sensitive to touch or disturbance of any kind and therefore it is preferable that the application of the honey composition to the wound be effected with minimal trauma to the recipient

Accordingly, in other embodiments of the present invention the applicator is in the form of a pressurised delivery can system where the contents of the pressurised can are able to be applied to a wide surface area by the use of appropriate nozzles therefore varying the spray pattern of the honey composition being transferred to the site.

It is envisaged that in some embodiments the applicator will be disposed of once the honey composition has been dispensed.

It is also envisaged that in some embodiments the applicator may be of a reusable type and will be able to have a sterile cap applied to the outlet of the applicator in order to reduce the chances of contamination of the applicator contents prior to the applicator being stored under appropriate conditions until it is needed to be used again.

In some embodiments of the present invention the nozzle assembly may be permanently fitted to the applicator.

Whereas, in other embodiments of the present invention, particularly where the use of sterile equipment is important, the nozzle may be a removable assembly that can be fitted to the applicator prior to dispensing any of the contents and can then be removed and sterilised or disposed of after the application has been completed.

The configuration of the nozzle may vary depending upon whether the honey composition is to be applied in a precise and limited area or dispensed over a wide area and also whether it is to be a single deposit, or a jet or spray.

The applicator nozzle may also be configured like a shower rose where particularly a fluid honey composition is to be applied over an extended area.

The applicator, whether in the form of a syringe-type applicator or as a pressurised can, may be externally configured to facilitate the appropriate gripping by the operator to ensure effective application of the honey based composition to the site.

Accordingly, finger rings or wings may be attached to the syringe, wherein these rings/wings or any other suitably configured attachment preferably extend from the body of the syringe reservoir in a substantially perpendicular plane to enable an operator to apply pressure to the syringe plunger whilst at the same time stabilising the syringe using the fingers of the same hand.

It is understood that the pressurised can may similarly include an appropriate gripping means, which may be indentations in the external surface of the can to facilitate the retention of the can within the operator's hand whilst the trigger mechanism is used to enable the contents of the can to be expelled from the reservoir.

In respect of the syringe-type applicator the seal is naturally broken when the honey composition is applied.

However as mentioned previously, a re-sealable cap may be employed and to avoid losing the cap, the cap may be fixed to the syringe body, either directly or indirectly, in an appropriate location to prevent loss of the cap during the application of the honey composition.

A similar attachment means may also be employed with the pressurised can embodiment.

Preferably, the syringe-type applicator is made from a material capable of being sterilised by irradiation.

The spray-can applicator may also be produced from any suitable material including stainless steel, that may be returned to the manufacturer to be sterilised and refilled, or may be made from a disposable material that is capable of being sterilised

Similarly, applicator nozzles of the syringe-type applicator may also be available in a range of materials that may be sterilised for reuse or be disposed of.

The use of the applicator enables application of the honey composition to a site and in a preferred quantity. Given the substance being applied to the wound is in fact a honey-based composition and not a traditional cream, ointment, salve, wash and so forth, there are various considerations regarding the product.

Preferably, the honey composition will include either (or both) non-active or/and “active” honey.

Such “active” honey includes honey derived from plants of the Leptospermum genus—such as Manuka in New Zealand.

In use “active” honeys have non-peroxide, anti-bacterial properties as well as peroxide properties.

These properties are beneficial in the treatment of infected and non-infected wounds, particularly exudating wounds.

The honey composition may be produced using honey in a range of forms from dried (spray, freeze, air or oven dried), creamed, and crystallised to liquid.

The various proportions of the different forms within the honey composition will in part effect a required viscosity, but primarily will dictate the concentrated form of the honey composition used.

In addition, the honey composition may optionally include a range of other agents such as gelling agents (for example, alginates, and so forth), pharmaceuticals, plant extracts, additional chemical compounds (including calcium to assist blood clotting), depending on the preferred properties required of the honey composition.

These agents may be synthetic or naturally produced. The proportion, type and number of additional agents added to the honey composition will be dictated by the preferred properties required to effect the desired wound care.

However, the nature of the pressurisation of the honey composition within the pressurised reservoir can effect a change in the viscosity of the honey-composition as it is delivered to the site. The depressurisation has been shown to effect a gelling of the honey composition to varying degrees.

For comparison, the honey composition within the syringe may have any suitable viscosity from substantially fluid to substantially gel-like, depending upon the wound type and extent to which the honey composition is to be applied.

A significant consideration in relation to the honey composition and applicator of the present invention is to minimise the pain and discomfort of the recipient during the treatment and healing process associated with wound care.

Typically (as previously discussed in the description of prior art application systems) significant pain and discomfort may be experienced when medicaments are applied to wounds.

Much of the discomfort arises from contact between the applicator and the wound. The above applicator attempts to address this problem. Pain is often experienced as a result of the composition applied to the wound and honey is no exception.

When unmodified honey comes in contact with open wounds or sores or particularly sensitive parts of the body, pain is experienced due to the acidity of the honey.

Discomfort experienced by the recipient may be decreased by neutralising, or at least partially neutralising, the acidity of the honey by the addition of an appropriate alkali.

When the alkali used has comparable therapeutic properties, the benefits of the substantially neutralised honey are enhanced.

In some preferred embodiments of the present invention the honey may be neutralised by stirring a solution of an appropriate alkali (for example, sodium hydroxide or potassium hydroxide) into the honey until the desired pH (usually pH 7) is achieved. This method provides a honey composition that is diluted by the water/solvent in which the alkali was dissolved.

This or a similar process may be applicable where a substantially fluid honey composition is preferred.

Alternatively, the quantity of dry alkali (such as calcium hydroxide) required to neutralise a preferred quantity of honey may be predetermined (for example by previously adding water to a weighed quantity of honey to make it substantially fluid and then measuring the quantity of dried alkali required to neutralise it).

Once the ratio of dried alkali to honey has been established it may then be applied to subsequent mixtures without the need to add a fluid. Instead, the honey may be warmed to effect its fluid nature and the dried alkali can then be stirred into the honey to disperse the solid/dried alkali throughout the honey.

This method provides a honey composition that is not diluted by water, which therefore may be advantageous where the honey composition is to be applied in a gel-like form.

As can be appreciated, there are variations possible in respect of the configuration of the applicator, nozzle, seals, and the honey composition as required to effect the preferred application of a desired honey composition to a site.

Such variation should be considered to fall within the scope of the present invention. The present invention should not be seen as limited only to the embodiments specifically described herein.

### BRIEF DESCRIPTION OF DRAWINGS

Further aspects of the present invention will become apparent from the following description which is given by way of example only and with reference to the accompanying drawings in which:

FIG. 1 is a diagrammatic top perspective view of the applicator means in accordance with one preferred embodiment of the present invention; and

FIG. 2 is a diagrammatic perspective view of sealing means for re-sealing the applicator means between subsequent applications in accordance with one preferred embodiment of the present invention; and

FIG. 3 is a diagrammatic perspective view of an applicator means in the form of the pressurised can, in accordance with another preferred embodiment of the present invention, and

FIGS. 4(a&b) are diagrammatic perspective views of variations in configuration of the nozzle means in accordance with preferred embodiments of the present invention.

### BEST MODES FOR CARRYING OUT THE INVENTION

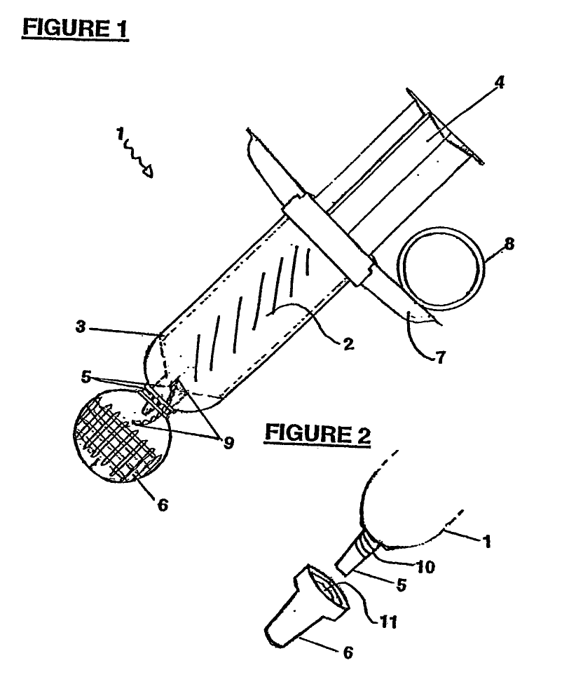

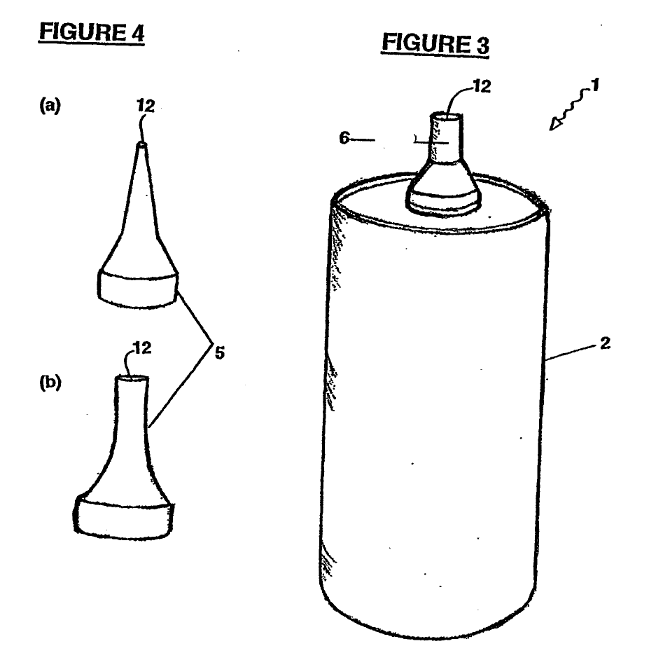

With reference to the diagrams there is provided an applicator (generally indicated by arrow 1) for applying a honey composition (2) topically to either or both wounds and wound dressings (as shown in the examples illustrated diagrammatically in FIGS. 1 and 3).

The applicator (1) includes a reservoir (3) for holding a preferred quantity of the honey composition (2) in a substantially fluid form.

There is also provided a pressure assembly (4) for effecting transfer of the honey composition (2) from the reservoir (3).

Where the applicator (1) is a syringe type applicator as in FIG. 1, the pressure assembly is a plunger (4).

In the embodiment represented by FIG. 3, the reservoir (3) has been filled with the honey composition (2) under pressure. Depression of a releasing valve (not shown) or similar trigger, enables the pressurised honey composition (2) to be expelled from the reservoir (3).

A nozzle means (5) (as shown in FIGS. 1, 2 and 4) is attached to, or is integral with the applicator (1) for directing the honey composition (2) in a preferred application to the wound and/or wound dressing.

The configuration of the nozzle (5) is determined by the required spread and quantity of the honey composition (2) to be applied to the wound and/or wound dressing. The spray or delivery pattern is effected by the configuration of the delivery aperture (12) of the nozzle (5) used.

In some applications, such as in areas requiring skin grafts and so forth where the extent of the wound covers a substantial area, the use of syringe-type applicators (1) may impact on the ability to apply the honey composition (2) efficiently and effectively. Applicators (1) having a greater capacity reservoir (3) would be preferable.

Further, an applicator (1) in the form of a pressurised delivery can system enables the contents of the pressurised can to be applied to a wide surface area by attaching appropriate nozzles (5) to vary the spray pattern of the honey composition (2) as required to be applied to the site.

The configuration of the applicator (1) whether in the form of a syringe-type applicator, or whether as a pressurised can, may be externally configured to facilitate appropriate gripping by the operator to ensure effective application of the honey based composition (2) to the wound and/or wound dressing.

Wings (7) or gripping rings (8) as shown in FIG. 1, may be applied to the syringe that extend from the body of the syringe in a substantially perpendicular plane, to enable an operator to apply pressure to the syringe plunger (4) whilst at the same time stabilising the syringe using the fingers of the same hand.

The pressurised can may similarly include appropriate gripping means (not shown) which may be indentations in the external surface of the can to facilitate appropriate retention of the can within the operator's hand and yet appropriate depression of the trigger mechanism to enable the contents of the can to be expelled (under pressure) from within the reservoir (3).

Optionally sealing/capping assemblies (6) are capable of resealing the applicator (1) and/or reservoir (3) in-between applications.

The nozzle (5) may be configured (at 10 as shown in FIG. 2) to engage with complementary configuration (11) of the sealing/capping assembly (6).

With the syringe-type applicator (1), the seal is naturally broken when the honey composition (2) is to be applied. However, as mentioned above a re-sealable cap (6) may be employed and to avoid losing the cap (6), the cap (6) may be fixed (at 9) to the syringe body via a chain or other securing device in an appropriate location to prevent loss of the cap (6) during the application of the honey composition (2).

A similar attachment means may also be employed with the pressurised can embodiment.

The honey composition (2) is in substantially fluid form when the reservoir (3) is filled but may by virtue of the pressure applied to the contents of the reservoir (3) be in substantially gel-form when applied to the wound and/or wound dressing.

As can be appreciated, there are variations possible in respect of the configuration of the applicator (1), nozzle (5), and sealing/capping (6) assemblies as required to effect the preferred application of a preferred honey composition (2) to a site.

Such variations should be considered to fall within the scope of the present invention.

The use of the applicator (1) enables application of the honey composition (2) in a preferred quantity, given the substance being applied to the wound is in fact a honey-based composition (2), and not a traditional cream, ointment, salve, wash and so forth.

Accordingly there are various considerations regarding the honey composition product.

### EXAMPLE 1

Preferred Ingredients of the Honey Composition

The honey may include varying percentages by weight of creamed or crystallised honey, spray dried, freeze-dried, oven dried, air dried and/or liquid honey.

The honey used may be either (or both) “active” honey having preferred non-peroxide, antibacterial/antimicrobial properties, non-active honey exhibiting peroxide activity, but not exhibiting non-peroxide antibacterial activity—as reasoned against phenol activity.

Optional ingredients including pharmaceuticals (antibiotics, fungicides, other antibacterial agents), vitamin extracts (Vitamin A and so forth), gelling agents, chemical compounds (calcium to promote blood clotting and so forth).

Neutralising agents—such as calcium hydroxide, potassium hydroxide, sodium hydroxide and so forth to produce a honey composition having a pH around pH 7.

### EXAMPLE 2

Methods for Neutralising the Honey Composition.

1. The honey may be neutralised by stirring a solution of an appropriate alkali (for example, sodium hydroxide or potassium hydroxide) into the honey until the desired pH (usually pH 7) is achieved.

The honey composition is diluted by the water/solvent in which the alkali is dissolved. This or a similar process may be applicable where a substantially fluid honey composition is preferred.

2. The quantity of dry alkali (such as calcium hydroxide) required to neutralise a preferred quantity of honey is predetermined (for example by previously adding water to a weighed quantity of honey to make it substantially fluid and then measuring the quantity of dried alkali required to neutralise it).

With the ratio of dried alkali to honey established it may then be applied to subsequent mixtures.

The honey is warmed to effect its fluid nature and the dried alkali is then stirred in to disperse the alkali throughout the honey. This method provides a honey composition that is not diluted by water, as may be advantageous where the honey composition is to be preferably applied in a gel-like form.

### EXAMPLE 3

Method of Applying the Honey Composition to a Wound and/or Wound Dressing using the Applicator Means.

A preferred sterile honey composition is applied to a wound and/or wound dressing by:

a) determining the preferred properties of the honey composition to be applied to the wound and/or wound dressing; and

b) determining the quantity of the preferred honey composition to be applied to the wound and/or wound dressing; and

c) removing the applicator's seal and where appropriate replace it with a nozzle required to effect the preferred application of the honey composition to the wound and/or wound dressing; and

d) applying pressure to, or effecting operation of, the pressure assembly (or its associated trigger) for the required time period to effect transfer of a preferred quantity of the honey composition from the reservoir of the applicator to the vicinity of the wound and/or wound dressing; and after said application;

e) re-sealing the output port of the reservoir with the sealing/capping assembly for subsequent use.

Once the honey composition has been applied to the wound, or to an appropriate dressing prior to the dressing being applied to the wound, the application of the honey may be repeated as required to effect the preferred care to the wound. Application may be undertaken at least once a day until infection is treated and/or the wound is substantially healed.

What I claim is:

1. An applicator for applying a honey composition topically a site, the applicator
including,
a sealable reservoir, and
a pressure assembly, and
a nozzle assembly, in fluid communication with each other once the seal is breached,
characterised in that
the sealable reservoir holds a preferred quantity of the honey composition in a fluid form and the pressure assembly is fitted to the reservoir in order to apply pressure to the honey composition contained within the reservoir, for effecting transfer of the honey composition from the reservoir and the nozzle assembly attached to the reservoir assembly directs the honey composition to the site.

2. An applicator as claimed in claim 1 wherein the site to which the honey composition is applied is either a wound or an item that is to be brought into contact with a wound.

3. An applicator as claimed in claim 1 for applying a honey composition to a site wherein the configuration of the nozzle assembly is determined by the required spread and quantity of the honey composition to be applied and ranges from a small aperture for use on sites with a minimal cross-sectional area, through a range of sizes and shapes to a broad or large nozzle for use with sites comprising a large cross sectional area.

4. An applicator as claimed in any previous claim wherein the honey composition used will have at least one of the following:
a preferred viscosity,
a preferred pH,
at least one preferred optional agent such as gelling agents, pharmaceuticals (for example antimicrobial, hormonal, vitamin compounds), chemical compounds such as calcium, plant extracts (for example flavonoids).

5. An applicator as claimed in any previous claim wherein the pressure assembly includes a plunger system.

6. An applicator as claimed in any previous claim wherein the reservoir is filled with the honey composition under pressure, the depression of a releasing valve enables the pressurised honey composition to be expelled from the reservoir.

7. An applicator as claimed in any previous claim wherein the pressure assembly includes at least one mechanical lever in order to assist its activation.

8. An applicator as claimed in any previous claim wherein the pressure assembly is activated using the assistance of hydraulic or pneumatic assemblies.

9. An applicator as claimed in any previous claim wherein the applicator is a single use disposable applicator.

10. An applicator as claimed in any of claims 1 to 8 wherein the applicator is cleaned, sterilised, and has a volume of honey composition placed into the reservoir, prior to sealing, in order that the applicator may be reusable.

11. A method of applying a honey composition to a site using an applicator substantially as described above, characterised by the steps of
a) determining the quantity of honey composition to be applied to the site; and
b) removing the seal of the reservoir and replacing it with the nozzle assembly to effect the preferred application of the honey composition to the site; and
c) effecting operation of pressure means for the required time period to transfer a preferred quantity of the honey composition from the reservoir of the applicator to the vicinity of the site.

12. An applicator substantially as herein described with reference to and as illustrated by the accompanying drawings.

13. A method of applying a honey composition as herein described with reference to and as illustrated by the accompanying drawings.

14. A honey composition as herein described with reference to and as illustrated by the accompanying drawings.
